(19) United States
(12) Patent Application Publication
(10) Pub. No.: US 2004/0042463 A1
(43) Pub. Date: Mar. 4, 2004

(54) Method and apparatus for address lookup

(75) Inventors: Miguel A. Guerrero, Fremont, CA (US); Prabhanjan Moleyar, Bangalore (IN); Ajith Prasad, Bangalore (IN); Muralidharan Chilukoor, Bangalore (IN); Simon L. Sabato, Sunnyvale, CA (US)

Correspondence Address: Pillsbury Winthrop LLP,, Intellectual Property Group, 1600 Tysons Boulevard, McLean, VA, 22102, US

(73) Assignee: Intel Corporation, Santa Clara, CA

(21) Appl. No.: 10/232,983

(22) Filed: Aug. 30, 2002

(51) Int. Cl. H04L 12/28; G06F 12/00

(52) U.S. Cl. 370/395.31; 370/389; 711/216

(57) ABSTRACT

An address lookup device provides information for a lookup value. A lookup value based on a network address in a received packet is received by a discriminant bits search device. A discriminant bits pattern is used to determine a location in an address lookup table based on the lookup value. The discriminant bits search device determines whether the lookup value is located in the location in the address lookup table. The discriminant bits search device outputs next hop information if the lookup value is located in the location in the address lookup table, and outputs default information if the lookup value is not located in the location in the address lookup table.

### RELATED APPLICATION

This application is related to U.S. patent application Ser. No. ______ filed on ______, entitled METHOD AND APPARATUS FOR HIGH-SPEED LONGEST PREFIX MATCH OF KEYS IN A MEMORY.

### BACKGROUND

1. Technical Field

This apparatus and invention relates to the field of data transmission in local area and global networks, e.g., an Internet, and, more specifically, to an apparatus and method to enable address lookup in forwarding and transferring devices of local area networks and the Internet.

2. Background

Current applications utilizing the Internet and local area networks (LANs), such as Internet video-on-demand or Internet telephony, require large amounts of data to be transferred from a LAN endsystem through the Internet to an endsystem or group of endsystems on other LANs.

Local area network switches (LAN switches) are evolving to handle the high-bandwidth issues within the LAN. LAN switches receive a packet of data and may perform error checks to verify that the packet has the necessary format. If the packet does not contain any errors, the LAN switch looks up the packet destination address in its switching table and determines the outgoing port to which the packet is to be transferred. The switching table includes a destination address list along with associated outgoing port interfaces. The LAN switch performs an “exact matching” search, meaning the destination address must exactly match a destination address entry in the switching table. The packet is then forwarded to the location associated with the switching table entry.

Internet data is transferred by groups of routers, which are interconnected by communication links. An individual router receives data packets on any of its input links and decides to which of its outgoing links the packet may be forwarded based on the packet's encoded destination protocol address. The router makes this determination by comparing the destination protocol address to its router table entries that, similarly to the LAN switch, contain destination protocol addresses and corresponding “next hop” instructions.

Unlike the LAN switch, however, the router performs a “longest prefix matching” search. Routing table entries may not contain the full length of all addresses. The destination protocol address is compared to routing table entries. The router utilizes the forwarding instructions of the entry with which the address has the longest prefix in common. The router changes the packet's destination physical address to the address of the next hop information and transmits it.

The link speed, data throughput rates, and packet forwarding rates in forwarding devices are all major factors in increasing bandwidth/throughput. Link speed is increased by improvements in cabling in both the LAN and the Internet. Faster switching technology is utilized to move packets from the device's input port to the corresponding output port at gigabit speeds. Packet forwarding, specifically the address lookup portion, is where a bottleneck exists.

Criteria in packet forwarding performance include the routing/switching table, i.e., address lookup table, size, the number of memory accesses required to retrieve the next hop information, and logic required to perform the search. Routing/switching tables require larger databases and memory because the number of destination addresses has grown exponentially.

Hardware implementations of “exact matching” schemes use parallelism to gain lookup speed. Parallelism is implemented using content addressable memories (CAMs) in which every memory location, in parallel, compares the input key value to the content of that memory location. CAMs are small, both in the number of bits per entry and the number of entries. Plus, CAMs for both large address/mask pairs, e.g., 256 bits needed for Internet Protocol Version 6—Ipv6, and CAMs for a large number of prefixes require extensive hardware logic.

The “exact matching” searching algorithm utilized by LAN switches is cumbersome with large routing tables because of the number of searches required to complete the search. This problem led router manufacturers to develop “longest prefix matching” searching schemes.

One of these schemes is a modified binary search technique, which requires log2 (2×N) steps, with N being the number of routing table entries. In the worst case, this scheme may require 17 data lookups for a 32-bit address, each requiring at least one memory access. Typical binary search schemes require an average number of accesses equal to log2 (2×N)−1.

Another scheme involves applying an “exact match” scheme for each possible prefix length, but this scheme is expensive because it requires W (number of bits) iterations for the “exact match” scheme used. This scheme also requires W memory accesses.

A radix tree implementation is the most commonly used “longest prefix matching” scheme. If W is the length of an address, the worst-case time to access in the basic implementation can be shown to be memory access time (O)×W×2. The worst case was improved to O×W by requiring that the prefix be contiguous, but this implementation requires up to 32 or 128 costly memory accesses, depending on the Internet protocol version.

### BRIEF DESCRIPTION OF THE DRAWINGS

FIG. 1 illustrates an address lookup device according to an embodiment of the present invention;

FIG. 2 illustrates placement of last addresses in a plurality of last address memory banks according to an embodiment of the present invention;

FIG. 3 illustrates contents of a plurality of last address memory banks in a three-stage pipelined binary search device according to an embodiment of the present invention;

FIG. 4 illustrates an extraction of a discriminant bits pattern according to an embodiment of the present invention;

FIG. 5 illustrates an address matching mask for each of a plurality of addresses in a memory section according to an embodiment of the present invention;

FIG. 6 illustrates a plurality of addresses for the memory section and the address matching masks for each of a plurality of addresses in the memory section according to an embodiment of the present invention; and

FIG. 7 illustrates a flowchart for an address lookup device according to an embodiment of the present invention.

### DETAILED DESCRIPTION

In one embodiment, a router or a local area network switch (LAN switch) receives a packet and may determine the next step in the packet's travel, e.g., the next hop information. The router or LAN switch extracts a lookup value based on a network address from the received packet and transfers the lookup value to an address lookup device. The lookup value may also be referred to as an input key. The address lookup device receives the lookup value and may perform a pipelined binary search to identify a memory section at which the lookup value should be located. In one embodiment, the address lookup device performs a discriminant bits search to determine if the lookup value is included in the memory section of a address lookup table, outputs the next hop information for the lookup value if the lookup value is included in the memory section of the address lookup table, and outputs a default next hop information if the lookup value is not included in the memory section of the address lookup table. In another embodiment, a pipelined binary search may not be performed, the address lookup device may perform a discriminant bits search on the address lookup table to determine if the lookup value is included in the address lookup table. If the lookup value is included in the address lookup table, next hop information may be output and if the lookup value is not included in the address lookup table, default next hop information is output. The forwarding device of the router or LAN switch may receive the next hop information or the default next hop information and transfer the packet to the location specified by the next hop information.

The address lookup device may only utilize one memory access to the address lookup table. In addition, the searching device's memory requirements may be low even for input address widths of 32 and 48 bits, and may be implemented utilizing standard synchronous dynamic random access memories (SDRAMs). Illustratively, if twelve 48-bit Ethernet addresses are stored in a section of memory, the address lookup device may only need to store 60 bits of information to be able to predict deterministically the only possible location of the lookup value in the address lookup table.

The lookup value may be the destination address, when utilizing the address lookup device in a local area network switch (LAN switch), or may be a destination protocol address, when utilizing the address lookup device in an Internet router.

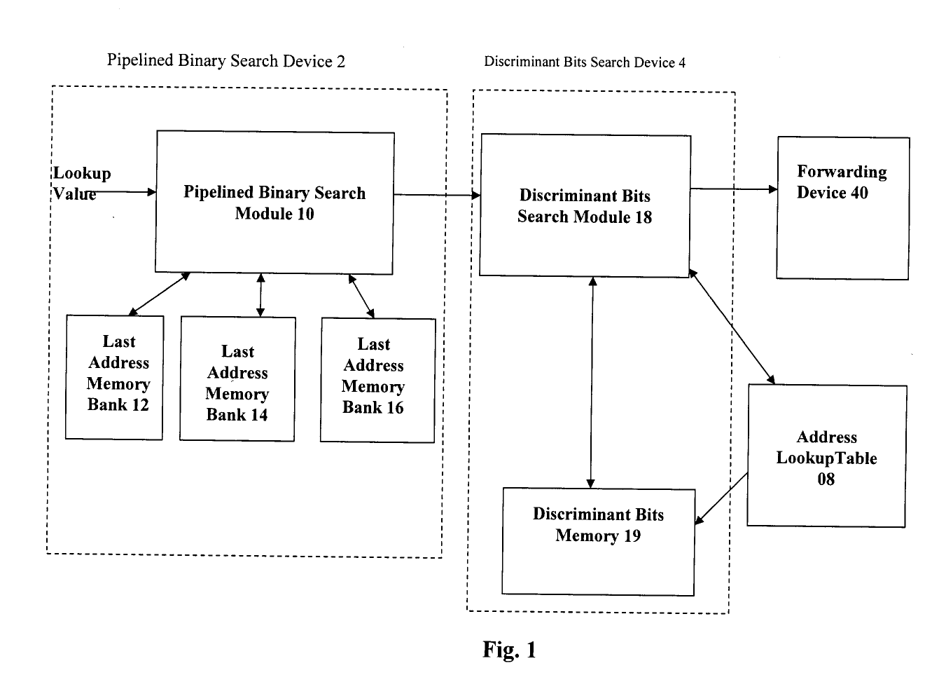

FIG. 1 illustrates an address lookup device according to an embodiment of the present invention. The address lookup device may include a pipelined binary search device 2, a discriminant bits search device 4, a forwarding device 40, and an address lookup table 8.

The pipelined binary search device 2 may include a pipelined binary search module 10 and a plurality of address memory banks 12 14 16. The pipelined binary search device 2 may receive a lookup value as input during each clock cycle and after a certain number of binary search stages identify a memory section of the address lookup table 8 at which the lookup value may be located if the lookup value is located in the address lookup table 8. Due to the pipelined nature of the pipelined binary search device 2, after a certain number of stages have been completed and each binary search stage is performing a search, one lookup value is input and one memory section is identified during each clock cycle.

In one embodiment, the address lookup table 8 may be divided into a number of memory sections, e.g., “c” sections, with each memory section having a number of addresses, e.g., “d” addresses. Thus, the address lookup table 8 may have (“c”×“d”) addresses in total. Each memory section may contain the same number of addresses. In one embodiment, the address lookup table 8 may be numerically organized in ascending order. In an alternative embodiment of the present invention, the address lookup table 8 may be numerically organized in a descending order.

In one embodiment, a last address of each memory section in the address lookup table 8 is extracted and placed in an address memory bank 12 14 16, referred to in this embodiment as a last address memory bank, based on what order in a binary search the memory section is searched. The last address memory banks 12 14 16 are internal to the pipelined binary search device 2, so the access speed is quick and no costly external memory, e.g., address lookup table, lookups are required. In this embodiment of the present invention, the arrangement of the last addresses in the last address memory banks 12 14 16 is based upon the operation of a binary search. The last addresses of the memory section are placed together in a separate last address memory bank if the last addresses are never accessed at the same time due to the nature of the binary search.

In another embodiment, a first address of each memory section in the routing switching table 8 is extracted and placed in a first address memory bank 12 14 16 based on what order in a binary search the memory section is searched. In this embodiment of the invention, the memory section may be sorted in a descending fashion.

For example, in a three-stage binary search utilizing last address memory banks, a first stage of the binary search may start at a middle last address. Thus, the middle last address may be placed in a first last address memory bank (1^{st} LAMB). Depending upon whether the destination address is less than or greater than the middle last address, a middle lower half last address (in the middle of the lower half of the table) is checked (if the lookup value is less than the middle last address) or the upper middle half last address is checked (if the lookup value is greater than the middle last address). Using this example, the middle lower half address and the upper middle half address are placed in the same last address memory bank, in this case a second last address memory bank (2^{nd} LAMB). Similarly, the four last addresses of the remaining memory banks are stored in a third LAMB. The four last addresses in the third LAMB are never searched at the same time due to the operation of the binary search.

In one embodiment, the number of last address memory banks (LAMBs) 12 14 16 may be proportional to the number of memory sections. Illustratively, 2^{LAMB}−1 is greater than or equal to the number of the memory sections, e.g., 2^{LAMB}−1>=c (number of memory sections). For example, if the address lookup table has been divided into seven sections, three last address memory banks are utilized, while if the forward/switching table is divided into fourteen sections, four last address memory banks may be utilized.

The number of binary search stages may be equivalent to the number of last address memory banks. Illustratively, if 7 memory sections are to be searched, three binary search stages and three last address memory banks are utilized to perform the binary search. If 25 sections of memory are searched, five binary search stages and five last address memory banks may be utilized to perform the binary search.

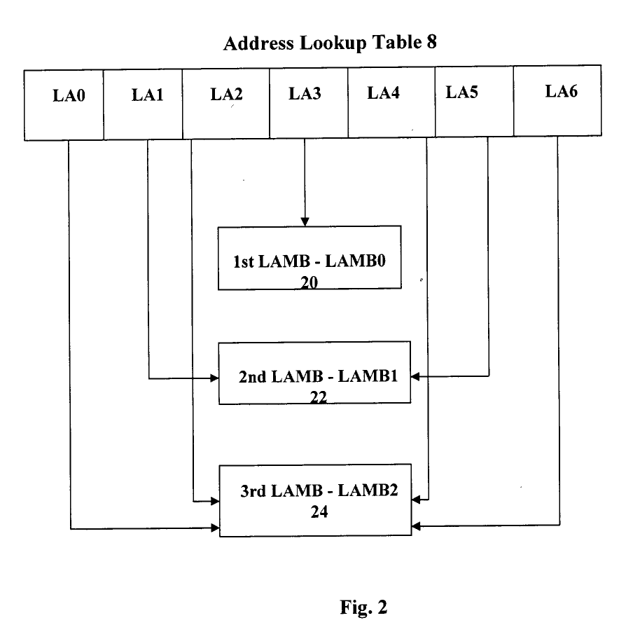

FIG. 2 illustrates placement of last addresses in a plurality of last address memory banks according to an embodiment of the address lookup device. Illustratively, a three stage binary search may operate in the following manner. In the first stage of the binary search, the middle last address (LA3) is compared to the lookup value. LA3 is placed in the first last address memory bank, e.g., LAMB0 20. Depending on whether the lookup value is less than or greater than the middle last address (LA3), the lookup value is compared to LA1 (if the lookup value is less than LA3) or is compared to LA5 (if the lookup value is greater than LA3) in the second stage of the binary search. Because LA5 and LA1 are never compared to the lookup value at the same time, these addresses may be placed in the second last address memory bank, e.g., LAMB1 22. Again, depending on whether the lookup value is less than or greater than either LA1 or LA5, the lookup value is compared to LA0 (if the lookup value is less than LA1), LA2 (if the lookup value is greater than LA1), LA4 (if the lookup value is less than LA5), or LA6 (if the lookup value is greater than LA5). Because LA0, LA2, LA4, and LA6 are never accessed for the same lookup value, these addresses are placed in LAMB2 24. Thus, the binary search may only, at worst case, take three stages and utilize three last address memory banks to determine the section of memory at which the lookup value should be located if the lookup value is present in the address lookup table.

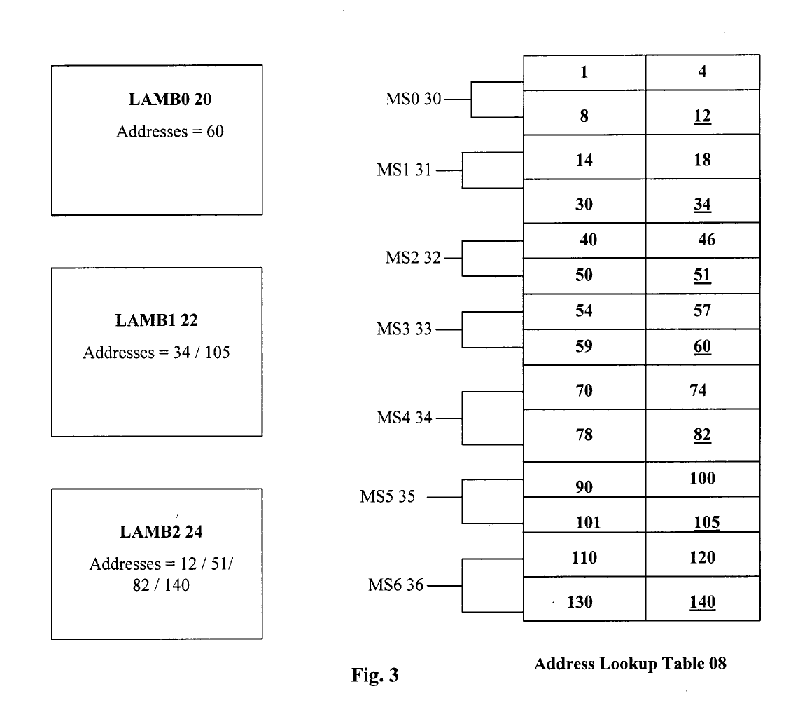

FIG. 3 illustrates the contents of a plurality of last address memory banks in a three-stage pipelined binary search device according to an embodiment of the present invention. In one embodiment of the present invention, the address lookup table 8 consists of seven memory sections (MS0 30, MS1 31, MS2 32, MS3 33, MS4 34, MS5 35, and MS6 36). The following addresses are illustratively located in the respective memory sections:

| MS0 = 1, 4, 8,12 | MS1 = 14, 18, 30, 34 | MS2 = 40, 46, 50, 51 |
|---|---|---|
| MS3 = 54, 57, 59, 60 | MS4 = 70, 74, 78, 82 | MS5 = 90, 100, 101, 105 |
| MS6 = 110, 120, 130, | | |
| 140 | | |

According to an embodiment of the address lookup device, the middle last address (LA3) is the last address of MS3 33 (60) and this value is placed in LAMB0 20. The last address of MS1 31 (LA1) is 34 and the last address of MS5 35 (LA5) is 105, and these two values are placed in LAMB1 22. Finally, the last address of MS0 30 (LA0) is 12; the last address of MS2 32 (LA2) is 51; the last address of MS4 34 (LA4) is 82; and the last address of MS6 36 (LA6) is 140. The last addresses LA0, LA2, LA4, and LA6 are all placed in LAMB2 24.

In one embodiment of the address lookup device, two lookup values having, for example, values of 46 and 100 may be input to the binary search device 2 to determine which memory section at which the addresses may be located if the addresses are in the address lookup table 8.

As illustrated in FIG. 3, in the first binary search stage for address 46, it is compared to the last address value of MS3 33, which is 60 and is located in LAMB0 20. Because it is less than 60, lookup value 46 is then compared to the last address of MS1 31, which is 34 and located in LAMB1 22 in the second binary search stage. Because 46 is greater than 34, lookup value 46 is then compared to the last address of MS2 32, which is 51 and is located in LAMB2 24 in the third binary search stage. Because lookup value 46 is less than 51 but greater than 34, lookup value 46 is located in MS2 32 if it is located in the address lookup table 8. The pipelined binary search device outputs the memory section MS2 32 along with the lookup value 46.

In the first binary search stage for lookup value 100, which may occur at the same time the second binary search stage for lookup value 46 takes place, lookup value 100 is compared to the value of 60, which is located in LAMB0 20. Because the lookup value 100 is greater than 60, input address 100 is then compared to the last address of MS5 35, which is 105 and located in LAMB1 22 in the second binary search stage. Because 100 is less than 105, the lookup value 100 is compared to the last address of MS4 34, which is 82 and located in LAMB2 24 in the third binary search stage. Because the lookup value 100 is greater than 82 but less than 105, the lookup value 100 is located in MS5 35. The pipelined binary search device 2 outputs memory section MS5 35 along with the lookup value 100.

The pipelined binary search device 2 may transmit the memory section at which the lookup value should be located along with the lookup value. The discriminant bits search device 4 may receive the lookup value and a reference to the memory section. Alternatively, the discriminant bits search device 4 may receive the lookup value and no reference to the memory section. The discriminant bits search device 4 may include a discriminant bits search module 18 and a discriminant bits memory 19 as illustrated in FIG. 1.

In one embodiment of the address lookup device during the pipelined binary search, it may be determined that the lookup value equals a last addresses of one of the plurality of last address memory banks. In another embodiment, it may be determined that the lookup value equals one of the first addresses in the plurality of first address memory banks. In such an embodiment, a discriminant bit search module may not be utilized. Because the pipelined binary search module has identified that the lookup value is equal to a location in the address lookup table 8, the address lookup device may directly access the location equal to the lookup value in the address lookup table 8 to determine the next hop address.

In one embodiment, the discriminant bits search module 18 may extract a discriminant bits pattern from the memory section of the address lookup table 8 identified by the reference input to the discriminant bits search device. Alternatively, the discriminant bits search module 18 may extract a discriminant bits pattern from the address lookup table 8. The discriminant bits pattern identifies which bit is the first different bit between consecutive addresses in a sorted memory. In one embodiment, the discriminant bits pattern may be extracted for only the memory section identified by the reference input to the discriminant bits search device from the pipelined binary search device 2. The discriminant bits pattern for the memory section may be placed in the discriminant bits memory 19. In one embodiment, the discriminant bits pattern may be extracted for a plurality of addresses in the memory section except for the last address of the memory section because if the lookup value is equal to the last address of the memory section, the lookup device, as described above, would access the address lookup table 8 without utilizing the discriminant bits search module 18. This may result in a smaller discriminant bits pattern.

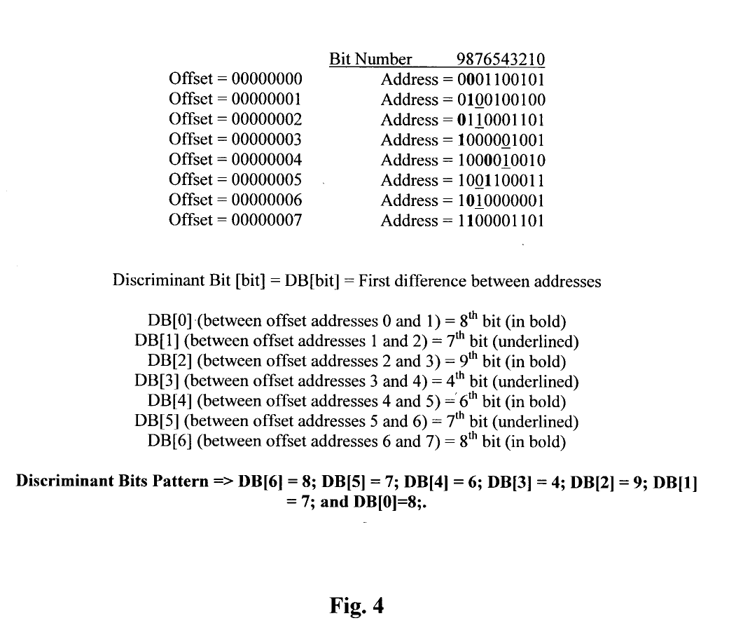

FIG. 4 illustrates an extraction of a discriminant bits pattern according to an embodiment of the address lookup device. Illustratively, the least significant discriminant bit, e.g., DB[0] is the first bit, moving from left to right, different between the address at offset 0 and the address at offset 1. In this example, DB[0]=8. Similarly, DB[1] is the first bit, from left to right, different between the address at offset 1 and the address at offset 2. The extraction works in a similar fashion to extract the final discriminant bits pattern of DB[6]=8; DB[5]=7; DB[4]=6; DB[3]=4; DB[2]=9; DB[1]=7; and DB[0]=8.

Alternatively, the discriminant bits pattern may be extracted from the complete address lookup table 8. The discriminant bits pattern for the address lookup table 8 may be placed in the discriminant bits memory 19. Alternatively, the discriminant bits search module 18 may only utilize the discriminant bits pattern for the memory section identified by the reference input to the discriminant bits search device in its operation. If a lookup value is inserted to the address lookup table 8, the discriminant bits pattern may be recalculated from the part of the table beyond the inserted lookup value.

Utilizing the memory section's discriminant bits pattern, the discriminant bits search module 18 may create an address matching mask a plurality of addresses in the memory section indicating the values of bits in the plurality of addresses in the memory section. Specifically, the created address matching mask for each of the plurality of addresses in the memory section may indicate which values must be one and which values must be zero based on the discriminant bits pattern for the plurality of addresses in the memory section. The values that do not have to be one or do not have to be zero may be either value and may be referred to as having a “do not care” value. Each-address in the memory section may have a unique address matching mask to represent it. Alternatively, the discriminant bits search module 18 may create an address matching mask for a plurality of addresses in the address lookup table 8.

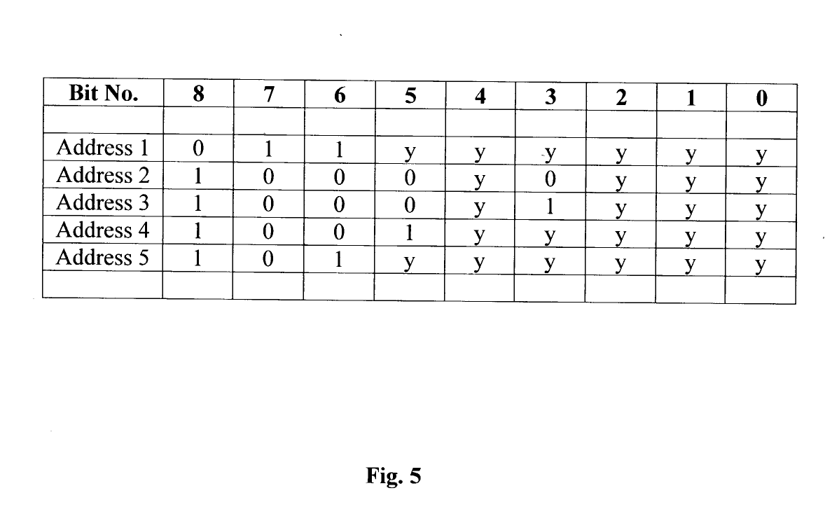

FIG. 5 illustrates an address matching mask for a plurality of addresses in a memory section according to an embodiment of the address lookup device. In the address masking mask for the plurality of addresses in the memory section, 1 means the value of a bit for the address must be one; 0 means the value of the bit for the address must be zero; and y means the value of the bit for the address may be either one or zero. Illustratively, in address 3, bit number 8 must have a value of 1; bit number 7 must have a value of 0; bit number 6 must have a value of 0; bit number 5 must have a value of 0; bit number 4's value may be either 0 or 1; bit number 3 must have a value of 1; and bit numbers 2, 1, 0's value may be either 0 or 1.

The discriminant bits search device 4 (see FIG. 1) may receive the lookup value from the pipelined binary search device 2, and the lookup value is received by the discriminant bits search module 18. Alternatively the discriminant bits search device 4 may receive the lookup value directly and the discriminant bits search module may act on the lookup value. The discriminant bits search module 18 may extract a reduced lookup value from the lookup value utilizing the discriminant bits pattern. The reduced lookup value is the lookup value encoded by the discriminant bits pattern.

In one embodiment of the present invention, the discriminant bits pattern is DB[0]=8; DB[1]=5; DB[2]=6; DB[3]=7; DB[4]=9; DB[5]=7; and DB[6]=6. Illustratively, a lookup value may be 0011000110. The reduced lookup value is extracted as follows. Going from most significant bit, e.g., DB[6] to least significant bit, e.g., DB[0], because DB[6]=6, the value of the sixth bit, i.e., 1, is the most significant bit of the reduced lookup value. DB[5]=7, and the value of the lookup value's seventh bit is 1, and is the next bit of the reduced lookup value. In a similar fashion, the remaining values of the reduced lookup value are extracted, yielding a reduced lookup value of 1101100.

A reduced address matching mask may also be extracted from the address matching mask for the plurality of addresses in the memory section utilizing the discriminant bits pattern. Alternatively, a reduced address matching mask may also be extracted from the address matching mask for the plurality of addresses in the address lookup table 8 utilizing the discriminant bits pattern. The reduced address matching mask for the plurality of addresses, in the memory section or the address lookup table, may be the address matching mask for the plurality of addresses, in the memory section or the address lookup table, encoded by the discriminant bits pattern. As above, in one embodiment, the discriminant bits pattern is DB[0]=8; DB[1]=5; DB[2]=6; DB[3]=7; DB[4]=9; DB[5]=7; and DB[6]=6. Illustratively, a table containing three address matching masks may have the following values:

Offset 3=0101yyyyyy

Offset 4=011yyyyyyy

Offset 5=1y0yyyyyyy (y means the value does not matter, e.g., can be either one or zero).

In one embodiment of the address lookup device, the reduced address matching mask may be extracted by encoding each of the address matching masks shown above as follows. The most significant bit of address 3, e.g., bit 6, has a discriminant bits value of 6. Therefore, the most significant bit of the reduced address matching mask for offset 3 is 1. The next most significant bit of address 3 has a discriminant bits value of 7. Thus, the next most significant bit of the reduced address masking mask for offset 3 is 0. Utilizing the same method, the entire reduced address matching mask for offset address 3 is 10001y1. Similarly, the reduced address matching mask for offset address 4 is y101yy1 and for offset address 5 it is y010yyy.

In the discriminant bits search module 18, the reduced lookup value may be compared to the reduced address matching mask for the plurality of addresses in the memory section to determine an individual address mask in the memory section that has all of its bits equal to the reduced lookup value. Alternatively, the reduced lookup value may be compared to the reduced address matcing mask for the plurality of addresses in the address lookup table to determine an individual address mask in the address lookup table 8 that has all of its bits equal to the reduced lookup value. The individual address mask with the equivalent bits may be a selected address masking mask. The selected address matching mask corresponds to a location in the address lookup table 8 where the lookup value may be located if the lookup value is located in the address lookup table 8.

Alternatively, the discriminant bits search module 18 may compare the lookup value to the address matching mask for the plurality of addresses in the memory section to determine the individual address mask in the memory section that has all of its bits equal to the lookup value. In another embodiment, the discriminant bits search module 18 may compare the lookup value to the address matching mask for the plurality of addresses in the address lookup table 8. The individual address mask again may be the selected address masking mask.

If the comparison is made between the reduced lookup value and the reduced address masking mask rather then the lookup value and the address matching mask, the hardware area needed to implement the comparison may be lessened. If the comparison is performed in software, the comparison between the reduced lookup value and the reduced address matching mask may be achieved at a faster speed than if the comparison is performed between the lookup value and the address matching mask in hardware, due to the reduced number of bits being compared.

Because only the selected mask address has been matched, the discriminant bits search module 18 may determine if a corresponding address in the address lookup table 8 to the selected matching address mask matches the lookup value by performing a search of the address lookup table 8. This function may be the only address lookup table memory access the address lookup device 2 undertakes. If the corresponding address is equivalent to the lookup value, (meaning the address corresponding to the selected matching address mask is equal to the lookup value) then the next hop information is retrieved from the corresponding address. The address lookup device may forward the next hop information to the forwarding device 40. If the selected matching address mask does not contain an address equivalent to the lookup value, default next hop information may be retrieved from the address lookup table 8 and the address lookup device may forward the next hop information to the forwarding device 40. Alternatively, default next hop information may be stored in any memory section of the address lookup device, i.e., the discriminant bits memory 19.

For example in one embodiment of the present invention, a memory section is selected by the pipelined binary search module 10. The memory section may contain the following record addresses that are listed below along with the binary representations of the addresses and the offset of the addresses from the beginning of the memory section.

In this embodiment of the present invention, two lookup values may have been transferred to the address lookup device to determine next hop information. For example, the first lookup value is 263 (1001100011) and the second lookup value is 280 (1010000001).

| | | |
|---|---|---|
| Offset = 00000000 | Record Address = 065 | 0001100101 |
| Offset = 00000001 | Record Address = 124 | 0100100100 |
| Offset = 00000002 | Record Address = 18d | 0110001101 |
| Offset = 00000003 | Record Address = 209 | 1000001001 |
| Offset = 00000004 | Record Address = 212 | 1000010010 |
| Offset = 00000005 | Record Address = 263 | 1001100011 |
| Offset = 00000006 | Record Address = 281 | 1010000001 |
| Offset = 00000007 | Record Address = 30d | 1100001101 |

Illustratively, the discriminant bits search module 18 (see FIG. 1) extracts a discriminant bit pattern from the memory section of the address lookup table 8. The discriminant bits pattern DB[0-6] may be as follows. DB[0]=8 (since the eighth bit is the first bit where there is a difference between the first and second address). Similarly, DB[1]=7; DB[2]=9; DB[3]=4; DB[4]=6; DB[5]=7 and DB[6]=8.

The discriminant bits pattern for the memory section may be stored in the discriminant bits memory 19. The discriminant bits memory 19 may be located internally to the discriminant bits search device 4. The discriminant bits search module 18 may extract the reduced lookup values utilizing the discriminant bits pattern from the two example lookup values, e.g., 1001100011 (263) and 1010000001 (280). The reduced lookup values may be as follows:

Reduced lookup value for 263=>0010100

Reduced lookup value for 280=>0100110

The discriminant bits search module 18 may create an address matching mask for each of a plurality of addresses in the memory section utilizing the discriminant bits pattern. The procedure for creating the mask is illustrated below. Because the discriminant bits pattern identifies that the first different bit is between two adjacent memory section addresses and the memory section addresses are listed in ascending order, the difference is always between a zero in the first address and a one in the second adjoining address.

The discriminant bit between the address with an offset of 0 and the address with an offset of 1 is the eighth bit, as illustrated below.

| | Bit Number | | | | | | | | |
|---|---|---|---|---|---|---|---|---|---|
| | 9 | 8 | 7 | 6 | 5 | 4 | 3 | 2 | 1 |
| Offset 0 | | 0 | | | | | | | |
| Offset 1 | | 1 | | | | | | | |

The discriminant bit between the address with an offset of 1 and the address with an offset of 2 is the seventh bit 7, as illustrated below. Also, the eighth bits of offset addresses 1 and 2 are the same, in this case, one, because the seventh bit is the first different bit between the two addresses.

| Bit Number | | | | | | | | |
|---|---|---|---|---|---|---|---|---|
| 9 | 8 | 7 | 6 | 5 | 4 | 3 | 2 | 1 |

| | | |
|---|---|---|
| Offset 1 | 0 | |
| Offset 1 | 1 | 0 |
| Offset 2 | 1 | 1 |

The discriminant bit between offset address 2 and offset address 3 is the ninth bit, as illustrated below. Because the ninth bits of offset addresses 1 and 2 are the same, and the ninth bits of offset addresses 0 and 1 are the same, the ninth bits of offset addresses 0 and 1 may be filled in with zeros.

| Bit Number | | | | | | | | |
|---|---|---|---|---|---|---|---|---|
| 9 | 8 | 7 | 6 | 5 | 4 | 3 | 2 | 1 |

| | | | |
|---|---|---|---|
| Offset 0 | 0 | 0 | |
| Offset 1 | 0 | 1 | 0 |
| Offset 2 | 0 | 1 | 1 |
| Offset 3 | 1 | | |

The discriminant bit between offset address 3 and offset address 4 is the fourth bit, as illustrated below. Because the first difference in bits is the fourth bit, all higher bits are equivalent. Thus, the ninth bit of offset address 4 is one.

| Bit Number | | | | | | | | |
|---|---|---|---|---|---|---|---|---|
| 9 | 8 | 7 | 6 | 5 | 4 | 3 | 2 | 1 |

| | | | | |
|---|---|---|---|---|
| Offset 0 | 0 | 0 | | |
| Offset 1 | 0 | 1 | 0 | |
| Offset 2 | 0 | 1 | 1 | |
| Offset 3 | 1 | | | 0 |
| Offset 4 | 1 | | | 1 |

The discriminant bit between offset address 4 and offset address 5 is the sixth bit. Again, the ninth bit of offset address 5 has an equivalent value to the ninth bit of offset address 4, as illustrated below, for the reasons discussed previously.

| Bit Number | | | | | | | | |
|---|---|---|---|---|---|---|---|---|
| 9 | 8 | 7 | 6 | 5 | 4 | 3 | 2 | 1 |

| | | | | | |
|---|---|---|---|---|---|
| Offset 0 | 0 | 0 | | | |
| Offset 1 | 0 | 1 | 0 | | |
| Offset 2 | 0 | 1 | 1 | | |
| Offset 3 | 1 | | | 0 | 0 |
| Offset 4 | 1 | | | 0 | 1 |
| Offset 5 | 1 | | | 1 | |

The discriminant bit between offset address 5 and offset address 6 is the seventh bit, as illustrated below. The address matching masks for some of the plurality of addresses in the memory section are further filled in because the 7th bit of offset addresses 4 and 5 are equivalent, along with the seventh bit of offset addresses 3 and 4.

| Bit Number | | | | | | | | |
|---|---|---|---|---|---|---|---|---|
| 9 | 8 | 7 | 6 | 5 | 4 | 3 | 2 | 1 |

| | | | | | |
|---|---|---|---|---|---|
| Offset 0 | 0 | 0 | | | |
| Offset 1 | 0 | 1 | 0 | | |
| Offset 2 | 0 | 1 | 1 | | |
| Offset 3 | 1 | | 0 | 0 | 0 |
| Offset 4 | 1 | | 0 | 0 | 1 |
| Offset 5 | 1 | | 0 | 1 | |
| Offset 6 | 1 | | 1 | | |

The discriminant bit between offset address 6 and offset address 7 is the eight bit, as illustrated below. The address matching masks for some of the plurality of addresses in the memory section are further filled in because the 8^{th} bit of offset addresses 3, 4, 5, and 6 are all equivalent, using techniques described previously. The address matching masks for each of the plurality of addresses in the memory section are filled out with y values to indicate that the value of the bit does not matter, e.g., can be zero or one.

| | Bit Number | | | | | | | | |
|---|---|---|---|---|---|---|---|---|---|
| | 9 | 8 | 7 | 6 | 5 | 4 | 3 | 2 | 1 |
| Offset 0 | 0 | 0 | y | y | Y | y | y | y | y |
| Offset 1 | 0 | 1 | 0 | y | Y | y | y | y | y |
| Offset 2 | 0 | 1 | 1 | y | Y | y | y | y | y |
| Offset 3 | 1 | 0 | 0 | 0 | Y | 0 | y | y | y |
| Offset 4 | 1 | 0 | 0 | 0 | Y | 1 | y | y | y |
| Offset 5 | 1 | 0 | 0 | 1 | Y | y | y | y | y |
| Offset 6 | 1 | 0 | 1 | y | Y | y | y | y | y |
| Offset 7 | 1 | 1 | y | y | Y | y | y | y | y |

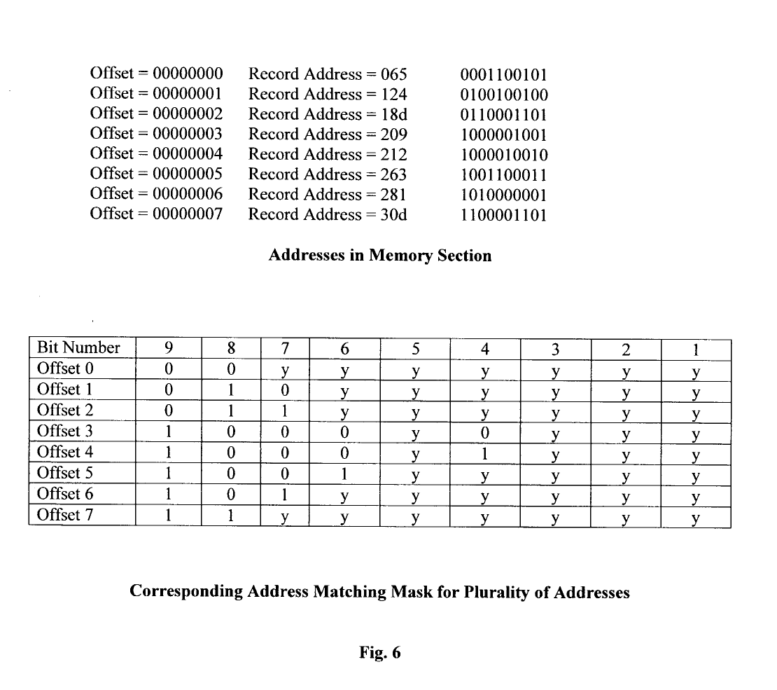

FIG. 6 illustrates the plurality of addresses for the memory section and the address matching masks for the plurality of addresses in the memory section. Illustratively, the matching address mask for offset 4, whose record address is 1000010010, is 1000y1yyy, where y may be a value of zero or one.

The discriminant bits mask, e.g., the address matching mask, has now been created for each of the plurality of addresses in the memory section. In one embodiment of the present invention, the lookup value may be compared to the address matching mask for each of the plurality of addresses in the memory section. For example, in the case of address 1001100011 (263), the lookup value matches the mask value for offset 5 and this value is the selected matching address mask. In the case of address 1010000001 (280), the lookup value matches the mask value for offset 6 and this value is the selected matching address mask.

In an alternative embodiment, the reduced lookup value may be compared to the reduced address matching mask for each of the plurality of addresses in the memory section. Illustratively, the reduced mask address for each of the plurality of addresses in the memory section illustrated above is:

| | | | | | | | |
|---|---|---|---|---|---|---|---|
| Offset 0 | 0 | Y | Y | Y | 0 | y | 0 |
| Offset 1 | 1 | 0 | Y | Y | 0 | 0 | 1 |
| Offset 2 | 1 | 1 | Y | Y | 0 | 1 | 1 |
| Offset 3 | 0 | 0 | 0 | 0 | 1 | 0 | 0 |
| Offset 4 | 0 | 0 | 0 | 1 | 1 | 0 | 0 |
| Offset 5 | 0 | 0 | 1 | Y | 1 | 0 | 0 |
| Offset 6 | 0 | 1 | Y | Y | 1 | 1 | 0 |
| Offset 7 | 1 | Y | Y | Y | 1 | y | y |

The reduced lookup value for 263 is 0010100. The reduced lookup value for 280 is 0100110. For lookup value 280, the reduced lookup value matches the reduced address matching mask for offset 5 and is the selected address matching mask. For lookup value 263, the reduced lookup value matches the reduced address matching mask for offset 6 and is the selected address matching mask. Note that the same result is obtained when comparing the lookup value to the address matching mask or comparing the reduced lookup value to the reduced address matching mask.

The discriminant bits search module 18 (see FIG. 1) may perform a search of the address lookup table 8 to determine if the address corresponding to the selected match address, is equivalent to the lookup value. Illustratively, in the case of lookup value 263, the address lookup table 8 does contain this address and the address lookup device may provide the next hop information to the forwarding device 40. Illustratively, in the case of lookup value 280, the address lookup table 8 does not contain the address, and the address lookup device provides default next hop information to the forwarding device 40.

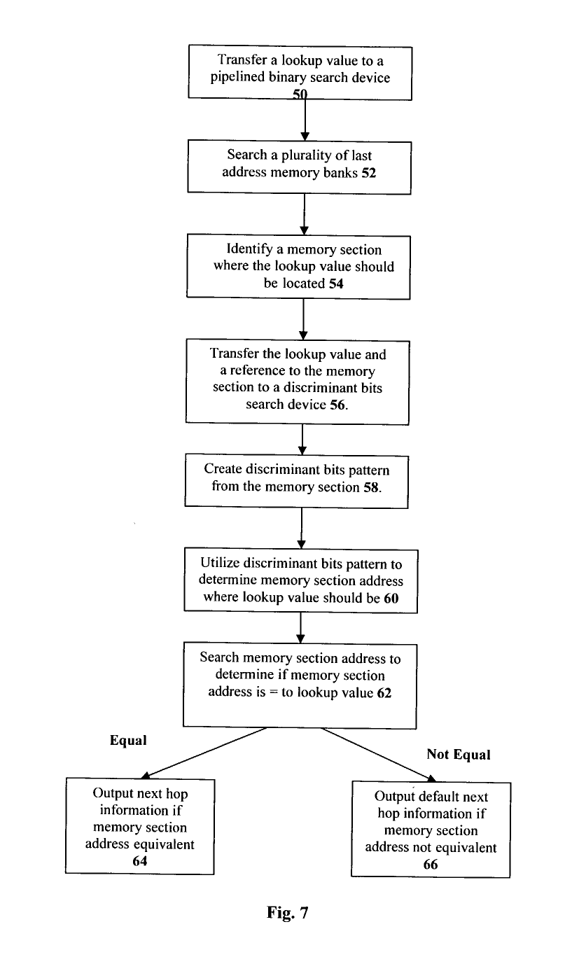

FIG. 7 illustrates a flowchart for an address lookup device according to an embodiment of the address lookup device. In an embodiment of the present invention, an address lookup device receives 50 a lookup value into a pipelined binary search device 2. A pipelined binary search 2 searches 52 a plurality of last address memory banks 12 14 16 to determine a memory section where the lookup value is located. The pipelined binary search device 2 identifies 54 the memory section where the lookup value should be located. The discriminant bits search device 4 receives 56 the lookup value only or the lookup value and a reference to the memory section where the lookup value should be located from the pipelined binary search device 2. A discriminant bits search module 18 creates 58 a discriminant bits pattern from the memory section where the lookup value should be located. The discriminant bits search module 18 utilizes 60 the discriminant bits pattern from the memory section where the lookup value should be located. The discriminant bits search module 18 searches 62 the memory section address to determine if the memory section address is equivalent to the lookup value. If the memory section address is equivalent to the lookup value, next hop information from the memory section address is output 64 by the discriminant bits search device 4. If the memory section address is not equivalent to the lookup value, default next hop information is output 66 by the discriminant bits search device 4.

While the description above refers to particular embodiments of the present invention, it will be understood that many modifications may be made without departing from the spirit thereof. The accompanying claims are intended to cover such modifications as would fall within the true scope and spirit of the embodiments of the present invention. The presently disclosed embodiments are therefore to be considered in all respects as illustrative and not restrictive, the scope of the embodiments of the invention being indicated by the appended claims, rather than the foregoing description, and all changes that come within the meaning and range of equivalency of the claims are intended to be embraced therein.

What is claimed is:

1. An address lookup device, comprising:
a discriminant bits search device to receive a lookup value based on a network address included in a received packet, to utilize a discriminant bits pattern to determine a location in an address lookup table based on the lookup value, and to access the location in the address lookup table.

2. The address lookup device of claim 1, wherein the network address is a destination address.

3. The address lookup device of claim 1, wherein the network address is a destination protocol address.

4. The address lookup device of claim 1, wherein the discriminant bits search device determines whether the lookup value is located in the location in the address lookup table.

5. The address lookup device of claim 4, wherein the discriminant bits search device outputs next hop information if the lookup value is located in the location in the address lookup table.

6. The address lookup device of claim 5, wherein the discriminant bits search device outputs default information if the lookup value is not located in the location in the address lookup table.

7. The address lookup device of claim 1, wherein a discriminant bits search module extracts the discriminant bits pattern from the address lookup table.

8. The address lookup device of claim 7, wherein the discriminant bits pattern is stored in a discriminant bits memory.

9. The address lookup device of claim 7, wherein the discriminant bits search module utilizes the discriminant bits pattern to create an address matching mask for a plurality of addresses in the address lookup table, a reduced address matching mask for the plurality of addresses in the address lookup table, and a reduced lookup value, and the discriminant bits search module finds a selected address matching mask where the reduced address matching mask for one of the plurality of addresses in the address lookup table has same bits as the reduced lookup value, and provides the one of the plurality of addresses having the same bits as the reduced lookup value as the location in the address lookup table.

10. The address lookup device of claim 7, wherein the discriminant bits search module utilizes a discriminant bits pattern to create an address matching mask of a plurality of addresses in the address lookup table, and the discriminant bits search module finds a selected address matching mask where the address matching mask for one of the plurality of addresses in the address lookup table has same bits as the lookup value, and provides the one of the plurality of addresses in the memory having the same bits as the lookup value as the location in the address lookup table.

11. The address lookup device of claim 1, further including:
a search device to receive the lookup value based on the network address, to search a plurality of address memory banks, and to identify a memory section of the address lookup table.

12. The address lookup device of claim 11, wherein the search device is a pipelined binary search device.

13. The address lookup device of claim 11, wherein the plurality of address memory banks are last address memory banks, and last addresses of memory sections are placed in the last address memory banks.

14. The address lookup device of claim 11, wherein the discriminant bits search device also receives a reference to the memory section identified by the search device.

15. The address lookup device of claim 14, wherein a discriminant bits search module extracts the discriminant bits pattern from the memory section the reference identifies.

16. The address lookup device of claim 15, wherein the discriminant bits pattern is stored in a discriminant bits memory.

17. The address lookup device of claim 15, wherein the discriminant bits search module utilizes the discriminant bits pattern to create an address matching mask for each of a plurality of addresses in the memory section, a reduced address matching mask for each of the plurality of addresses in the memory section, and a reduced lookup value, and the discriminant bits search module finds a selected address matching mask where the reduced address matching mask for one of the plurality of addresses in the memory section has same bits as the reduced lookup value and provides the one of the plurality of addresses having the same bits as the reduced lookup value as the location in the address lookup table.

18. The address lookup device of claim 15, wherein the discriminant bits search module utilizes the discriminant bits pattern to create an address matching mask for each of a plurality of addresses in the memory section, and the discriminant bits search module finds a selected address matching mask where the address matching mask for one of the plurality of addresses in the memory section has same bits as the lookup value and provides the one of the plurality of addresses in the memory having the same bits as the lookup value as the location in the address lookup table.

19. A method for address lookup, comprising:
receiving a lookup value based on a network address in a discriminant bits search device;
creating a discriminant bits pattern for an address lookup table;
utilizing the discriminant bits pattern and the lookup value to determine a location in the address lookup table; and
accessing the location in the address lookup table.

20. The method of claim 19, further including,
searching the location in the address lookup table to determine if the location in the address lookup table has a value equivalent to the lookup value; and
outputting next hop information for the lookup value if the location in the address lookup table has a value equivalent to the lookup value.

21. The method of claim 19, further including,
searching the location in the address lookup table to determine if the location in the address lookup table has a value equivalent to the lookup value; and
outputting default if the location in the address lookup table does not have a value equivalent to the lookup value.

22. The method of claim 19, further including,
utilizing, by a discriminant bits search module, the discriminant bits pattern to create an address matching mask for each of a plurality of addresses in the address lookup table, a reduced lookup value, and a reduced address matching mask for each of the plurality of addresses in the address lookup table;
comparing the reduced address matching mask for each of the plurality of addresses in the address lookup table to the reduced lookup value to find a selected address matching mask where the reduced address matching mask for one of the plurality of addresses in the address lookup table has same bits as the reduced lookup value; and
providing the one of the plurality of addresses in the address lookup table having the same bits as the reduced lookup value as the location in the address lookup table.

23. The method of claim 19, further including,
utilizing, by a discriminant bits search module, the discriminant bits pattern to create an address matching mask for each of a plurality of addresses in the address lookup table;
comparing the address matching mask for each of the plurality of addresses in the address lookup table to the lookup value to find a selected address matching mask where the address matching mask for one of the plurality of addresses in the address lookup table has same bits as the lookup value; and
providing the one of the plurality of addresses in the address lookup table having the same bits as the lookup value as the location in the address lookup table.

24. The method of claim 19, wherein the address lookup table includes a plurality of memory sections.

25. The method of claim 24, wherein a memory section is identified by inputting the lookup value based on a network address to a pipelined binary search device, and by searching a plurality of address memory banks to determine the memory section of the plurality of memory sections in the address lookup table where the lookup value is located.

26. The method of claim 25, wherein the plurality of address memory banks are last address memory banks, and last addresses of the plurality of memory sections are placed in a plurality of the last address memory banks.

27. The method of claim 25, wherein a discriminant bits search module creates the discriminant bits pattern of the memory section.

28. The method of claim 27, further including:
utilizing, by a discriminant bits search module, the discriminant bits pattern to create an address matching mask for each of a plurality of addresses in the memory section, a reduced lookup value, and a reduced address matching mask for each of the plurality of addresses in the memory section;
comparing the reduced address matching mask for each of the plurality of addresses in the memory section to the reduced lookup value to find a selected address matching mask where the reduced address matching mask for one of the plurality of addresses in the memory section has same bits as the reduced lookup value; and
providing the one of the plurality of addresses in the memory section having a reduced address matching mask with the same bits as the reduced lookup value as the location in memory.

29. The method of claim 27, further including:
utilizing, by a discriminant bits search module, the discriminant bits pattern to create an address matching mask for each of a plurality of addresses in the memory section;
comparing the address matching mask for each of the plurality of addresses in the memory section to the lookup value to find a selected address matching mask where the address matching mask for one of the plurality of addresses in the memory section has same bits as the lookup value; and
providing the one of the plurality of addresses in the memory section having an address matching mask with the same bits as the lookup value as the location in memory.

30. A Layer 2 switching device to transfer a packet between a plurality of endsystems on a local area network, comprising:
a packet receiving device to accept the packet and to extract a lookup value based on a destination address;
an address lookup device, including
a discriminant bits search device to receive the lookup value based on the network address included in the packet, to utilize a discriminant bits pattern to determine a location in an address lookup table based on the lookup value, and to access the location in the address lookup table, and
a forwarding device to forward the packet to a next location.

31. The switching device of claim 30, further comprising a pipelined binary search device to receive the lookup value based on the network address, search a plurality of address memory banks, and identify a memory section in the address lookup table.

32. The switching device of claim 31, wherein the plurality of address memory banks are last address memory banks, and last addresses of memory sections are placed in the last address memory banks.

33. A Layer 3 routing device to transfer a packet on a global network, comprising:
a packet receiving device to accept the packet and to extract a lookup value based on a destination protocol address;
an address lookup device, including,
a discriminant bits search device to receive the lookup value based on the network address, to utilize a discriminant bits pattern to determine a location in an address lookup table based on the lookup value, and to access the location in the address lookup table, and
a forwarding engine to forward the packet to a next location.

34. The routing device of claim 32, further including a pipelined binary search device to receive the lookup value based on the network address, search a plurality of address memory banks, and identify a memory section in the address lookup table.

35. The routing device of claim 34, wherein last addresses of memory sections are placed in a plurality of last address memory banks based on when the pipelined binary search device searches the last addresses of the memory sections.

36. A program code storage device, comprising:
a machine-readable storage medium; and
machine-readable program code, stored on the machine-readable storage medium, the machine-readable program code having instructions to
receive a lookup value based on a network address in a discriminant bits search device;
create a discriminant bits pattern for an address lookup table;
utilize the discriminant bits pattern and the lookup value to determine a location in the address lookup table; and
access the location in the address lookup table.

37. The program code storage device of claim 36, further including instructions to
search the location in the address lookup table to determine if the location in the address lookup table has a value equivalent to the lookup value; and
output next hop information for the lookup value if the location in the address lookup table has a value equivalent to the lookup value.

38. The program code storage device of claim 36, further including instructions to
search the location in the address lookup table to determine if the location in the address lookup table has a value equivalent to the lookup value; and
output default if the location in the address lookup table does not have a value equivalent to the lookup value.

39. The program code storage device of claim 36, further including instructions to
utilize, by a discriminant bits search module, the discriminant bits pattern to create an address matching mask for each of a plurality of addresses in the address lookup table, a reduced lookup value, and a reduced address matching mask for each of the plurality of addresses in the address lookup table;
compare the reduced address matching mask for each of the plurality of addresses in the address lookup table to the reduced lookup value to find a selected address matching mask where the reduced address matching mask for one of the plurality of addresses in the address lookup table has same bits as the reduced lookup value; and
provide the one of the plurality of addresses in the address lookup table having the same bits as the reduced lookup value as the location in the address lookup table.

40. The program code storage device of claim 36, further including instructions to
utilize, by a discriminant bits search module, the discriminant bits pattern to create an address matching mask for each of a plurality of addresses in the address lookup table;
compare the address matching mask for each of the plurality of addresses in the address lookup table to the lookup value to find a selected address matching mask where the address matching mask for one of the plurality of addresses in the address lookup table has same bits as the lookup value; and
provide the one of the plurality of addresses in the address lookup table having the same bits as the lookup value as the location in the address lookup table.

41. The program code storage device of claim 36, wherein the address lookup table includes a plurality of memory sections.

42. The program code storage device of claim 41, wherein a memory section is identified by inputting the lookup value based on a network address to a pipelined binary search device, and by searching a plurality of address memory banks to determine the memory section of the plurality of memory sections in the address lookup table where the lookup value is located.

43. The program code storage device of claim 42, wherein the plurality of address memory banks are last address memory banks, and last addresses of the plurality of memory sections are placed in a plurality of the last address memory banks.

44. The program code storage device of claim 42, wherein a discriminant bits search module creates the discriminant bits pattern of the memory section.

45. The program code storage device of claim 44, further including instructions to
utilize, by a discriminant bits search module, the discriminant bits pattern to create an address matching mask for each of a plurality of addresses in the memory section, a reduced lookup value, and a reduced address matching mask for each of the plurality of addresses in the memory section;
compare the reduced address matching mask for each of the plurality of addresses in the memory section to the reduced lookup value to find a selected address matching mask where the reduced address matching mask for one of the plurality of addresses in the memory section has same bits as the reduced lookup value; and
provide the one of the plurality of addresses in the memory section having a reduced address matching mask with the same bits as the reduced lookup value as the location in memory.

46. The program code storage device of claim 44, further including instructions to
utilize, by a discriminant bits search module, the discriminant bits pattern to create an address matching mask for each of a plurality of addresses in the memory section;
compare the address matching mask for each of the plurality of addresses in the memory section to the lookup value to find a selected address matching mask where the address matching mask for one of the plurality of addresses in the memory section has same bits as the lookup value; and
provide the one of the plurality of addresses in the memory section having an address matching mask with the same bits as the lookup value as the location in memory.
